(19) United States
(12) Patent Application Publication
(10) Pub. No.: US 2020/0001548 A1
(43) Pub. Date: Jan. 2, 2020

(54) METHOD OF FORMING A STRUCTURAL COMPOSITE AND STRUCTURAL COMPOSITE OBTAINED THEREBY

(71) Applicant: DOWAKSA USA LLC, Midland, MI (US)

(72) Inventors: Davoud ZAMANI, Tuscon, AZ (US); Hamid SAADATMANESH, Tuscon, AZ (US); Oksana PILATOVA, Horgen KI (CH)

(21) Appl. No.: 16/487,686

(22) PCT Filed: Feb. 21, 2018
(86) PCT No.: PCT/US2018/018968

§ 371 Date: Aug. 21, 2019

Related U.S. Application Data
(60) Provisional application No. 62/461,461, filed on Feb. 21, 2017.

(51) Int. Cl. B29C 70/08; B29C 70/30; B32B 37/15

(52) U.S. Cl. CPC B29C 70/088; B29C 70/30; B29K 2307/04; B29K 2909/06; B32B 37/15

(57) ABSTRACT

A method of forming a structural composite is disclosed. The method comprises combining an uncured resin and a carbon fiber textile to form a first layer. The method also comprises forming a second layer comprising uncured concrete adjacent the first layer, wherein the uncured concrete of the second layer is in contact with the uncured resin of the first layer. Finally, the method comprises curing the first and second layers, thereby forming the structural composite. A structural composite produced by the above method is also disclosed.

### CROSS-REFERENCE TO RELATED APPLICATIONS

This application claims priority to and all of advantages of U.S. Prov. Appl. Ser. No. 62/461,461, filed on 21 Feb. 2017, the content of which is herein incorporated by reference.

### FIELD OF THE INVENTION

The present invention generally relates to a method of forming a structural composite and, more specifically, to a method of forming a structural composite comprising first and second layers, and to a structural composite formed in accordance with the method.

### DESCRIPTION OF THE RELATED ART

Conventional structural elements formed from steel and/or concrete are known to deteriorate over time, decreasing their long-term durability and structural integrity. In particular, steel structural elements are prone to losing their structural integrity due to corrosion when exposed to wet weather conditions and the like. Corrosion is especially a problem for steel structural elements used in coastal areas, which can be compounded by seawater.

Concrete structural elements are also subject to deterioration over time when exposed to water. For example, in areas that are subject to the changing weather conditions, moisture trapped in the concrete structural elements may freeze and expand, thus resulting in the cracking of the concrete structural elements.

Furthermore, the effectiveness of conventional reinforcing methods for structural elements is limited, as corrosion is also known to occur to the steel reinforcements used inside concrete structural elements. Conventional techniques, such as epoxy coating and painting and/or galvanizing or passivating the steel reinforcements, have not been successful over long periods of time, especially in severe weather environments.

In addition to water-based deterioration, both concrete and steel structural elements can fail in known seismic zone areas. Observations from earthquakes have shown that certain structural elements, such as foundations, are susceptible to significant damage when subjected to loads induced by large seismic events.

### SUMMARY OF THE INVENTION

The present invention provides a method of forming a structural composite. The method comprises (i) combining an uncured resin and a carbon fiber textile to form a first layer. The method further comprises (ii) forming a second layer comprising uncured concrete adjacent the first layer. The uncured concrete of the second layer is in contact with the uncured resin of the first layer. Finally, the method comprises (iii) curing the first and second layers, thereby forming the structural composite.

A structural composite formed in accordance with the method is also provided.

### DESCRIPTION OF THE DRAWINGS

Other advantages of the present invention will be readily appreciated, as the same becomes better understood by reference to the following detailed description when considered in connection with the accompanying drawings, wherein:

FIG. 1 shows a structural composite formed in accordance with one embodiment of the method;

FIG. 2 shows a structural composite formed in accordance with another embodiment of the method;

FIG. 3a shows a structural composite formed in accordance with a further embodiment of the method;

FIG. 3b shows an alternative structural composite formed in accordance with another embodiment of the method;

FIG. 3c shows a further structural composite formed in accordance with yet another embodiment of the method; and

FIG. 4 shows an exploded view of a structural composite formed in accordance with one embodiment of the method.

### DETAILED DESCRIPTION OF THE INVENTION

The present invention provides a method of forming a structural composite. The structural composite is typically utilized in or as a component of a structure, such as a building, bridge, foundation, bulkhead, and the like. The method and elements disclosed herein can be utilized for constructing new structures and structural elements, retrofitting existing structures and structural elements, and repairing or rehabilitating structures and structural elements damaged by corrosion, deterioration, warp, excessive loading, and the like. As will be described in further detail below, the structural composite may independently be of any suitable size, proportion, and/or shape. Likewise, multiple structural composites may be independently utilized as individual components of the structures and/or structural elements.

The method includes (i) combining an uncured resin and a carbon fiber textile and to form a first layer.

The uncured resin used to form the first layer may comprise any uncured resin or combination of resins known in the art.

The term “resin” is conventionally used to describe a natural or synthetic polymer capable of being cured and/or hardened (i.e., uncured and/or unhardened). However, the term “resin” is also conventionally used to denote a natural or synthetic polymer in a cured and/or hardened state. As such, the term “resin” may be used to refer to a cured and/or hardened resin, or to an uncured and/or unhardened resin. Accordingly, it is to be understood that, as used herein, the term “resin” may refer to a cured or uncured resin, and the terms “cured resin” and “uncured resin” are used to differentiate between a particular resin in a cured or uncured state.

The resin may be a thermosetting and/or thermoplastic resin. Typically, suitable resins comprise the reaction product of a monomer and a curing agent. Such resins are conventionally named/identified according to a particular functional group present in the reaction product. For example, the term “polyurethane resin” represents a polymeric compound comprising a reaction product of an isocyanate (i.e., a monomer) and a polyol (i.e., a chain extender/curing agent). The reaction of the isocyanate and the polyol create urethane functional groups, which were not present in either of the unreacted monomer or curing agent. In certain instances, however, resins are named according to a particular functional group present in the monomer (i.e., a cure site). For example, the term “epoxy resin” represents a polymeric compound comprising a cross-linked reaction product of a monomer having one or more epoxide groups (i.e., an epoxide) and a curing agent. However, once cured, the epoxy resin is no longer an epoxy, or no longer includes epoxide groups, but for any unreacted or residual epoxide groups (i.e., cure sites), which may remain after curing, as understood in the art. In other instances, however, resins may be named according to a functional group present in both the monomer and the reaction product (i.e., an unreacted functional group)

Furthermore, it is to be understood that the terms “curing agent” and “cross-linking agent” can be used interchangeably. Curing agents suitable for use in forming resins are typically at least difunctional molecules that are reactive with functional groups present in a resin-forming monomer. For example, curing agents suitable for use in forming epoxy resins are typically at least difunctional molecules that are reactive with epoxide groups (i.e., comprise two or more epoxide-reactive functional groups).

It is also to be understood that the term “cured” refers to a composition or component that has undergone at least some cross-linking, e.g. at an amount of from about 50 to about 100, about 60 to about 100, about 70 to about 100, about 80 to about 100, or about 90 to about 100% of available cure sites. Additionally, the term “uncured” refers to the composition when it has undergone little or no cross-linking. However, it is to be understood that some of the available cure sites in an uncured composition may be cross-linked. Likewise, some of the available cure sites in a cured composition may remain uncross-linked. Thus, the terms “cured” and “uncured” may be understood to be functional and/or descriptive terms. For example, an uncured resin is typically characterized by a solubility in organic solvents and an ability to undergo liquid and/or plastic flow. In contrast, a cured resin suitable for the practice of the present invention is typically characterized by an insolubility in organic solvents and an absence of liquid and/or plastic flow under ambient conditions.

As introduced above, the resin may be a thermosetting and/or thermoplastic resin. Examples of suitable thermosetting and/or thermoplastic resins typically include epoxy, polyester, phenol, polyamide, polyimide, polyvinyl, polyvinyl ester (i.e., vinylester), and polyurethane resins, as well as modifications, and combinations thereof. Additionally, elastomers and/or rubbers can be added to or compounded with the uncured thermosetting and/or thermoplastic resin to improve certain properties such as impact strength.

Other specific examples of suitable thermosetting and/or thermoplastic resins include polyamides (PA); polyesters such as polyethylene terephthalates (PET), polybutylene terephthalates (PET), polytrimethylene terephthalates (PTT), polyethylene naphthalates (PEN), liquid crystalline polyesters, and the like; polyolefins such as polyethylenes (PE), polypropylenes (PP), polybutylenes, and the like; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyetheretherketones (PEEK); polyetherketoneketones (PEKK); polyarylates (PAR); polyethernitriles (PEN); resol-type; urea (e.g. melamine-type); phenoxy resins; fluorinated resins, such as polytetrafluoroethylenes; thermoplastic elastomers, such as polystyrene types, polyolefin types, polyurethane types, polyester types, polyamide types, polybutadiene types, polyisoprene types, fluoro types, and the like; and copolymers, modifications, and combinations thereof.

In some embodiments the resin is an epoxy resin, which may be a thermosetting and/or thermoplastic epoxy resin. In such some embodiments, the epoxy resin comprises an epoxide-containing monomer (i.e., an “epoxide”) and a curing agent.

Examples of suitable epoxides include aliphatic, aromatic, cyclic, acyclic, and polycyclic epoxides, and modifications and combinations thereof. The epoxide may be substituted or unsubstituted, and hydrophilic or hydrophobic. The epoxide may have an epoxy value (equiv./kg) of about 2 or greater, such as from about 2 to about 10, about 2 to about 8, about 2.5 to about 6.5, about 5 to about 10, about 2 to about 7, or about 4 to about 8. Specific examples of suitable epoxides include glycidyl ethers of biphenol A and bisphenol F, epoxy novolacs (such as epoxidized phenol formaldehydes), naphthalene epoxies, trigylcidyl adducts of p-aminophenol, tetraglycidyl amines of methylenedianiline, triglycidyl isocyanurates, hexahydro-o-phthalic acid-bis-glycidyl ester, hexahydro-m-phthalic acid-bis-glycidyl ester, hexahydro-p-phthalicacid-bis-glycidyl ester, and modifications and combinations thereof.

Examples of curing agents suitable for use in the epoxy resin include polyols, such as glycols and phenols. Particular examples of phenols include biphenol, bisphenol A, bisphenol F, tetrabromobisphenol A, dihydroxydiphenyl sulfone, phenolic oligomers obtained by the reaction of above mentioned phenols with formaldehyde, and combinations thereof. Additional examples of suitable curing agents include anhydride curing agents such as nadic methyl anhydride, methyl tetrahydrophthalic anhydride, and aromatic anhydrides such pyromellitic dianhydride, biphenyltetracarboxylic acid dianhydride, benzophenonetetracarboxylic acid dianhydride, oxydiphthalic acid dianhydride, 4,4′-(hexafluoroisopropylidene) diphthalic acid dianhydride, naphthalene tetracarboxylic acid dianhydrides, thiophene tetracarboxylic acid dianhydrides, 3,4,9,10-perylenetetracarboxylic acid dianhydrides, pyrazine tetracarboxylic acid dianhydrides, 3,4,7,8-anthraquinone tetracarboxylic acid dianhydrides, oligomers or polymers obtained by the copolymerization of maleic anhydride with ethylene, isobutylene, vinyl methyl ether, and styrene, and combinations thereof. Further examples of suitable curing agents include maleic anhydride-grafted polybutadiene.

In some embodiments the resin is a polyamide resin, which may be a thermosetting and/or thermoplastic polyamide resin. Examples of suitable polyamides include those formed by the reaction of a diamine monomer and a diacid crosslinker. Specific examples of such suitable polyamides include polycaproamide (Nylon 6), polyhexamethyleneadipamide (Nylon 66), polytetramethyleneadipamide (Nylon 46), poly hexamethylenesebacamide (Nylon 610), polyhexamethyl enedodecamide (Nylon 612), polyundecaneamide, poly dodecaneamide, hexamethyleneadipamide/caproamide copolymer (Nylon 66/6), caproamide/hexamethyleneterephthalamide copolymer (Nylon 6/6T), hexamethyleneadipamide/hexamethyleneterephthalamide copolymer (Nylon 66/6T) hexamethyleneadipamide/hexamethyleneisophthalamide copolymer (Nylon 66/61), hexamethyleneadipamide/ hexamethyleneisophthalamide/caproamide copolymer (Nylon 66/61/6), hexamethyleneadipamide/hexamethylene terephthalamid/carpoamide copolymer (Nylon 66/6T/6), hexamethyleneterephthalamide/hexamethyleneisophthala mide copolymer (Nylon 6T/61), hexamethyleneterephthalamide/dodecanamide copolymer (Nylon 6T/12), hexamethyleneadipamide/hexamethyleneterephthalamide/hexamethyleneisophthalamide copolymer (Nylon 66/6T/61), polyxylyleneadipamide, hexamethyleneterephthalamide/2-methyl pentamethyleneterephthalamide copolymer, polymetaxylylenediamineadipamide (Nylon MXD6), polynonamethyleneterephthalamide (Nylon 9T), and combinations thereof.

In certain embodiments the resin is a phenol resin, which may be a thermosetting and/or thermoplastic phenol resin. Examples of suitable phenol resins include resins prepared by homopolymerizing or copolymerizing components containing at least a phenolic hydroxyl group, and optionally a cross-linker. In certain embodiments, the phenol resin is prepared without a cross-linker. Specific examples of suitable phenol resins include phenolic resins such as phenolnovolaks, cresolnovolaks, octylphenols, phenylphenols, naphtholnovolaks, phenolaralkyls, naphtholaralkyls, phenolresols, and the like, as well as modified phenolic resins such as alkylbenzene modified (especially, xylene modified) phenolic resins, cashew modified phenolic resins, terpene modified phenolic resins, and the like. Further examples of suitable phenol resins include 2,2-bis(4-hydroxyphenyl)propane (generally referred to as bisphenol A), 2,2-bis(4-hydroxyphenyl)methane, 1,1-bis(4-hydroxyphenypethane, 1,1-bis(4-hydroxyphenyl)cyclohexane, 2,2-bis(4-hydroxy-3,5-dimethylphenyppropane, 2,2-bis(4-hydroxy-3,5-dibromophenyl)propane, 2,2-bis(hydroxy-3-methylphenyl)propane, bis(4-hydroxyphenyl)sulfide, bis(4-hydroxy-phenyl)sulfone, hydroquinone, resorcinol, 4,6-dimethyl-2,4,6-tri(4-hydroxyphenyl)heptene, 2,4,6-dimethyl-2,4,6-tri(4-hydroxyphenyl)heptane, 2,6-dimethyl-2,4,6-tri(4-hydroxyphenyl)heptene, 1,3,5-tri(4-hydroxyphneyl)benzene, 1,1,1-tri(4-hydroxyphenyl) ethane, 3,3-bis(4-hydroxyaryl)oxyindole, 5-chloro-3,3-bis(4-hydroxyaryl)oxyindole, 5,7-dichloro-3,3-bis(4-hydroxyaryl) oxyindole, 5-brome-3,3-bis(4-hydroxyaryl) oxyindole, and combinations thereof.

In particular embodiments the resin is a polyester resin, which may be a thermosetting and/or thermoplastic polyester resin. Examples of suitable polyester resins include polycondensation products of a polycarboxylic acid and a polyol, ring-opened polymers of a cyclic lactone, polycondensation products of a hydroxycarboxylic acid, and polycondensation products of a dibasic acid and a polyol. It is to be appreciated that the term “polyol” as used herein is meant to describe a molecule with at least two —OH functional groups (e.g. alcohol, hydroxy and/or hydroxyl functional groups). Particular examples of suitable polyols include polyetherpolyols, diols such as glycols, triols such as glycerine, 1,2,6-hexanetriol, trimethoxypropane (TMP), and triethoxypropane (TEP), sugar alcohols such as erythtitol, lactitol, maltitol, mannitol, sorbitol, and xylitol, and the like, as well as combinations and modifications thereof. Other suitable polyols include biopolyols such as castor oil, hydroxylated fatty esters (e.g. hydroxylated glycerides), hydroxylated fatty acids, and the like, as well as modifications and/or combinations thereof. Specific examples of suitable polyester resins include polyethylene terephthalate resins, polypropylene terephthalate resins, polytrimethylene terephthalate resins, polybutylene terephthalate resins, polyethylene naphthalate resins, polybutylene naphthalate resins, polycyclohexanedimethylene terephthalate resins, polyethylene-1,2-bis(phenoxy) ethane-4,4′-dicarboxylate resins, polyethylene-1,2-bis(phenoxy)ethane-4,4′-dicarboxylate resins, as well as copolymer polyesters such as polyethylene isophthalate/terephthalate resins, polybutylene terephthalate/isophthalate resins, polybutylene terephthalate/decanedicarboxyate resins, and polycyclohexanedimethylene terephthalate/isophthalate resins, and combinations thereof.

In some embodiments the resin is a polyvinyl resin, which may be a thermosetting and/or thermoplastic polyvinyl resin. Examples of suitable polyvinyl resins include polymerization products of molecules comprising vinyl, vinylidene, and/or vinylene functional groups. Specific examples of polyvinyl resins include those formed from vinylhalides such as vinyl chloride, vinylarenes such as styrene, vinyl esters, and the like, as well as combinations and/or modifications thereof. Specific examples of suitable polyvinyl resins include polyvinyl ester resins, such as homopolymer, copolymer, and di-, tri-, and/or poly-block polymer products of vinyl esters. Examples of suitable vinyl esters include vinyl alkanoates such as vinyl acetates, vinyl stearates, vinyl decanoates, vinyl valerates, vinyl pivalate, and the like, vinyl benzoates, vinyl formates, vinyl cinnamates, and the like, as well as combinations and/or modifications thereof.

In certain embodiments, the resin is a polyurethane resin, which may be a thermosetting and/or thermoplastic polyurethane resin. Examples of suitable polyurethanes include condensation products of a polyisocyanate and a polyol, such as those polyols described herein. Examples of suitable polyisocyanates include diisocyanates such as aromatic diisocyanates (e.g. toluene diisocyanate (TDI), methylene diphenyl diisocyanate (MDI), and naphthalene diisocyanate (NDI)), alkylisocyanates (e.g. hexamethylene diisocyanate (HDI) and methylene bis-cyclohexylisocyanate (HMDI)), and aliphatic diisocyanates (e.g., isophorone diisocyanate (IPDI)), and the like, as well as combinations, modifications, and self-polymerization products thereof.

The carbon fiber textile used to form the first layer comprises carbon fiber(s). It is to be appreciated that the term “carbon fiber(s)” can denote and encompasses a single fiber of carbon and/or a plurality of carbon fibers. Herein, use of the term “carbon fiber(s)” denotes one or more individual fibers of carbon, which can be independently selected based on composition, size, length, and the like, or combinations thereof. For clarity and consistency, reference to “the carbon fiber(s)” is made herein, which may relate to a single fiber of carbon, or all of the fibers of carbon, utilized, as the individual fibers may be independently selected and different from one another. The carbon fiber(s) may be, independently, processed, randomized, woven, treated, or the like, or combinations thereof.

The carbon fiber(s) of the carbon fiber textile comprises a fibrous material comprising, consisting of, or consisting essentially of, graphene, graphite, and/or combinations thereof. The carbon fiber(s) may be or include polyacrylonitrile (PAN)-type, pitch type, or Rayon type carbon, or combinations thereof. The carbon fiber(s) may be in any form, such as single layer fibers, multilayer fibers, nanotubes, and combinations thereof. Likewise, the carbon fiber(s) may be formed into thread, filament, yarn, tow, strand, or the like.

It is to be understood that the term “textile,” as used herein in the context of the carbon fiber textile, is meant to describe an article formed from the carbon fiber(s) by at least one processing technique, such as filament winding, pultrusion, weaving, braiding, knitting, knotting, crocheting, felting, interlacing, interlocking, bonding, and the like. Accordingly, in some embodiments the carbon fiber textile comprises a carbon fiber fabric, cloth, canvas, weave, and/or screen. In particular embodiments, the carbon fiber textile comprises a carbon fiber fabric.

It is also to be understood that the carbon fiber textile need not be a single, contiguous textile, but rather may be any number of individual carbon fiber textiles, which may be the same as or different than one another. The first layer typically comprises multiple, individual carbon fiber textiles, each comprising independently selected dimensions including weight, size, shape, height, width, length, color, thickness, and the like. In certain embodiments, the carbon fiber textile of the first layer comprises multiple, individual carbon fiber textiles with the same, similar, or different dimensions as one another, each formed from a single piece of carbon fiber textile via cutting, shaping, and the like, or combinations thereof. In particular embodiments, the first layer comprises multiple carbon fiber textiles, each having a substantially similar color and thickness, and independently selected shapes, lengths and/or widths. In some embodiments, however, the first layer comprises a single piece of the carbon fiber textile.

In some embodiments, the first layer further comprises a second resin. Typically, the resin is a thermosetting and/or thermoplastic resin, such as those described above. Accordingly, the second resin may be or comprise the same and/or different resin(s) as the uncured resin of the first layer. The first layer typically comprises the second resin in a cured state, and in combination with the carbon fiber(s) of the carbon fiber textile. Such a combination of the cured second resin and the carbon fiber(s) may be conventionally referred to as a “carbon fiber”, such that combining the carbon fiber textile and the uncured resin to form the first layer comprises combining the uncured resin with a carbon fiber.

In certain embodiments, the carbon fiber textile and/or carbon fiber may be pre-cast into a particular shape, which can be selected based on a use of the structural composite. The particular shape may be any shape or combination of shapes suitable for use in a structural composite. Accordingly, in some embodiments, the method further includes pre-casting the carbon fiber textile. The carbon fiber textile may be precast before, during, or after combination with the uncured resin. As such, the carbon fiber textile may be manufactured and/or purchased in a pre-cast state, and thus prior to being utilized in the method. Conversely, in some embodiments, forming the first layer further comprises pre-casting the carbon fiber textile.

Typically, combining the uncured resin and the carbon fiber textile comprises wetting or saturating the carbon fiber textile with the uncured resin to form the first layer. However, any method of combining the uncured resin and the carbon fiber textile and may be utilized.

It is to be understood that the term “wetting” as used herein describes any contacting, moistening, or covering of at least a portion of the carbon fiber textile with the uncured resin. Likewise, it is also to be understood that the term “saturating” as used herein is meant to describe contacting, moistening, or covering all of the carbon fiber textile with the uncured resin. Wetting is distinguished from saturating by virtue of the amount of uncured resin utilized and whether the carbon fiber textile is capable of absorbing or directly contacting any additional amount of the uncured resin. Furthermore, any method suitable for contacting, moistening, or covering a portion or all of the carbon fiber textile with the uncured resin can be used to wet or saturate the carbon fiber textile with the uncured resin. In certain embodiments, combining the carbon fiber textile and the uncured resin comprises dip coating, roll coating, spray coating, flow coating, spin coating, drop coating, or brushing the carbon fiber textile with the uncured resin. In some embodiments, combining the carbon fiber textile and the uncured resin comprises wetting or saturating the carbon fiber textile with the uncured resin via wet/hand lay-up, spray lay-up, saturating machine, vacuum infusion, and the like. In specific embodiments, combining the carbon fiber textile and the uncured resin comprises combining the carbon fiber textile in the uncured resin. The uncured resin may be disposed on the carbon fiber textile, or the carbon fiber textile may be disposed in the uncured resin, e.g. in a vessel.

In certain embodiments, the carbon fiber textile is wetted or saturated with an uncured epoxy resin, such as one of the epoxy resins described above, in an uncured state. In some embodiments, the carbon fiber textile is wetted or saturated with a polyester resin, such as one of the polyester resins described above, in an uncured state. In further embodiments, the carbon fiber textile is wetted or saturated with a vinyl resin, such as one of the vinyl resins described above, in an uncured state. In particular embodiments, the carbon fiber textile is wetted or saturated with a polyurethane resin, such as one of the polyurethane resins described above, in an uncured state. In certain embodiments, the carbon fiber textile is wetted or saturated with an uncured phenol resin, such as one of the phenol resins described above, in an uncured state. The carbon fiber textile may be wetted or saturated with different types of uncured resins or combinations of uncured resins. In addition, when one or more of the uncured resins are formed via a reaction between two or more components, the carbon fiber textile may be wetted or saturated with the components, a reaction intermediary thereof, the reaction product thereof, etc. Typically, the uncured resin comprises a viscosity such that the uncured resin is flowable. Forming the resin in situ when in contact with the carbon fiber textile is within the scope of combining the uncured resin and the carbon fiber textile. The components of the uncured resin may react prior to being combined with the carbon fiber textile, as they are being combined with the carbon fiber textile, and/or upon being combined with the carbon fiber textile. The components of the uncured resin may be separately metered and combined, and may be combined together during combination with the carbon fiber textile.

Typically, forming the first layer comprises wetting or saturating one or more pieces of the carbon fiber textile with the uncured resin. As such, forming the first layer may comprise merely wetting or saturating the carbon fiber textile with the uncured resin. Alternatively, forming the first layer may comprise wetting or saturating the carbon fiber textile with the uncured resin and applying the wetted or saturated piece of carbon fiber textile to the surface of a substrate. The substrate may be any substrate compatible with the first layer. Typically, the substrate is a structural element, such that forming the first layer comprises disposing the uncured concrete onto a surface of the structural element. As such, in some embodiments, the structural composite is integral with the structural element, as described in further detail below. The structural element may be any component of a structure, such as a foundation, floor, wall, roof, support, column, pile, or slab. Additionally, the structural element may comprise any suitable material(s) known in the art, such as concrete, fiberglass, steel, wood, and/or stone.

Furthermore, the uncured resin is typically selected based on adhesive properties and utilized as an adhesive between the one or more pieces of the carbon fiber textile and the surface of the substrate. Accordingly, forming the first layer may comprise disposing multiple wetted or saturated pieces of the carbon fiber textile onto the surface of the substrate. Likewise, forming the first layer may comprise disposing the wetted or saturated pieces of the carbon fiber textile onto the surface of the substrate manually, mechanically, pneumatically, hydraulically, and the like, or combination thereof. Furthermore, the first layer may be formed on any portion of the surface of the substrate, or on the entire surface of the substrate, such that the first layer comprises the same or different dimensions (i.e., length and/or height) as the surface of the substrate. It is also to be appreciated that the first layer may be formed on multiple surfaces of the substrate.

The method also includes (ii) forming a second layer comprising uncured concrete adjacent the first layer.

The second layer is formed adjacent the first layer, such that the uncured resin of the first layer is in contact with the uncured concrete of the second layer, which is described in further detail below. It is to be appreciated that “contact” encompasses both complete and partial contact. As such, the second layer need not be formed such that all of the uncured resin is in contact the uncured concrete, nor all of the uncured concrete in contact with the uncured resin. Rather, any portion of the uncured concrete of the second layer may be in contact with any portion of the uncured resin of the first layer.

Typically, the uncured resin of the first layer is disposed at least between and in contact with each of the carbon fiber textile of the first layer and the uncured concrete of the second layer. It is to be appreciated, however, that either one of the first and second layers may be formed prior to forming the other, or both of the first and second layers may be formed concurrently with one another. Accordingly, in some embodiments, the first layer is formed prior to forming the second layer. In other embodiments, the second layer is formed prior to forming the first layer. In certain embodiments, the first and second layers are formed concurrently.

As set forth above, the second layer comprises uncured concrete. The term “concrete” as used herein is meant to describe a composition comprising at least a binder phase, a filler phase, and water, which composition forms a hard composite material when cured. As such, it is to be appreciated that the term “concrete” may be used to describe such a composition in terms of either or both cured and/or uncured states. A cured concrete is typically hardened an incapable of undergoing fluid-like flow. Comparatively, an uncured concrete is typically capable of undergoing at least some type of fluid-like flow. It is to be appreciated that an uncured concrete may be completely uncured, or merely partially uncured. Thus, in at least the context of the concrete, the terms “cured” and “uncured” may be understood to be functional and/or descriptive terms. Accordingly, the term “uncured concrete” as used herein is meant to describe a composition comprising the binder phase, the filler phase, and water in an uncured state.

It is to be appreciated that the concrete used in the present invention may be formulated in any suitable manner. Typically, the concrete is formulated based on the intended use of the structural composite. Accordingly, in some embodiments, the concrete is an expanding-type, a non-shrinking-type, or a shrinking-type concrete. Likewise, in certain embodiments, the concrete is a wet-mix concrete, a dry-mix concrete, or a combination thereof.

Typically, the binder phase comprises an inorganic matrix-forming material. In specific embodiments, the inorganic matrix-forming material is a cement. It is to be appreciated that the cement may be a dry cement powder, a wet cement paste, or a hardened cement, depending on the state of the concrete. The cement may also comprise a geopolymer cement, such as a slag-based geopolymer cement, a rock-based geopolymer cement, a fly ash-based geopolymer cement, a ferro-sialate-based geopolymer cement, and the like, or combinations and/or modifications thereof. Examples of suitable cements include Portland cements such as those having an American Society of Testing Materials (ASTM) category I-V designation, rapid hardening cements, quick setting cements, low heat cements, slag cements, alumina cements, white cements, colored cements, pozzolanic cements, air entraining cements, hydrographic cements, sulfates resisting cement, and the like, or combinations thereof. In particular embodiments, the cement is a calcium silicate cement.

The filler phase may be any material that can interact with the binder phase to form the concrete. Typically, the filler phase comprises aggregate. Examples of suitable aggregate include sand, soil, gravel, rocks, waste byproducts, recycled materials, minerals, and the like, or combinations thereof. Specific examples of suitable aggregate include granite aggregates, scabbled stone aggregates, gravel aggregates, limestone aggregates, secondary aggregates such as crushed concrete, bricks, asphalt and the like, slag aggregates, and combinations thereof.

The uncured concrete of the second layer comprises water. It is to be appreciated that water may be added to the binder phase and/or the filler phase separately or in combination to form the concrete. In specific embodiments, water is added to a combination of the binder phase and the filler phase. In certain embodiments, the binder phase and the filler phase are combined in the presence of water.

The concrete may further comprise an additive such as an air entrainer, a colorant, a pigment, a fiber, a hydration accelerator, a hydration retarder, a water reducer, a plasticizer, a non-shrinking additive, a shrink reducer, a fast-set additive, an anti-corrosion additive, a set-retarder, an accelerator, a plasticizer, a solvent, and the like, or combinations thereof. The concrete may also comprise a polymeric modifier. Suitable polymeric modifiers include latexes, acrylates, acrylics, epoxies, vinyls, and the like, as well as copolymers, combinations, and modifications thereof.

In particular embodiments, the concrete comprises a compound reactive with the uncured resin of the first layer. Suitable compounds include catalysts, cross-linkers, chain extenders, curing accelerators, curing inhibitors, and the like, and combinations thereof.

The uncured concrete may be formed in any manner suitable for combining together the binder phase, filler phase, water, and, if any, the additives and other components. Similarly, forming the uncured concrete may comprise combining together each of the components in any order to form the uncured concrete. Likewise, forming the uncured concrete may comprise combining together any two or more of the components to form a pre-mix, prior to combining the pre-mix with any one or more of the other components. Furthermore, forming the uncured concrete may utilize wet-mixing, dry-mixing, or a combination thereof. Such mixing may be performed manually, mechanically, pneumatically, hydraulically, and the like, or combination thereof.

The second layer may be formed by any suitable method for forming a layer of a structural composite. Typically, the uncured concrete is formed prior to forming the second layer. As such, forming the second layer typically comprises disposing the uncured concrete onto a surface of a substrate. The substrate may be any substrate compatible with the second layer. Typically, the substrate is the first layer. Accordingly, forming the second layer typically comprises disposing the uncured concrete onto the first layer. Alternatively, the uncured concrete is formed in situ on the first layer. However, in certain embodiments, the substrate is a structural element, such that forming the second layer comprises disposing the uncured concrete onto a surface of the structural element, or forming the uncured concrete in situ on the surface of the structural element. In such certain embodiments, the structural composite may further comprise the structural element, as described in further detail below. The structural element may be any component of a structure, such as a foundation, floor, wall, roof, support, column, pile, or slab. Additionally, the structural element may comprise any suitable material(s) known in the art, such as concrete, carbon fiber, fiberglass, steel, wood, stone, and/or dirt.

Forming the second layer may comprise pouring, spraying, rolling, dumping, and/or packing the uncured concrete onto the surface of the substrate. Likewise, forming the second layer may comprise disposing the uncured concrete onto the surface of the substrate manually, mechanically, pneumatically, hydraulically, and the like, or combination thereof. It is to be appreciated that forming the second layer may comprise disposing multiple, discrete portions of the uncured concrete onto the surface of the substrate. Likewise, forming the second layer may comprise disposing any one of the multiple, discrete portions of the uncured concrete into any particular shape and/or pattern on the surface of the substrate. Typically, particular shapes and/or patterns are independently selected based on the formulation of the uncured concrete and/or the intended use of the structural composite. In certain embodiments, forming the second layer comprises disposing the uncured concrete onto the surface of the substrate. In particular embodiments, forming the second layer comprises disposing multiple, discrete portions of the uncured concrete onto the surface of the substrate. In some embodiments, each portion of the uncured concrete is disposed onto the surface of the substrate in an individually selected pattern and/or shape.

It is also to be appreciated, however, that forming the second layer may comprise forming the uncured concrete in situ on the surface of the substrate. Furthermore, the second layer may be formed on any portion of the surface of the substrate, or on the entire surface of the substrate, such that the second layer comprises the same or different dimensions (i.e., length, height, and/or width) as the surface of the substrate. It is also to be appreciated that the second layer may be formed on multiple surfaces of the substrate. Accordingly, in some embodiments, forming the second layer comprises forming the uncured concrete in situ on the surface of the substrate. In particular embodiments, the uncured concrete is formed in situ on the first layer.

Similarly, it is to be appreciated that the first layer may be disposed adjacent to the second layer, or the second layer may be disposed adjacent the first layer. Accordingly, in some embodiments, the method comprises disposing the second layer adjacent the first layer. In other embodiments, the method comprises disposing the first layer adjacent the second layer.

The uncured resin of the first layer need not be disposed between all portions of the carbon fiber textile and the uncured concrete. In other words, in some embodiments, the structural composite comprises a portion of the carbon fiber textile in contact with a portion of the uncured concrete. In certain embodiments, however, the uncured resin is disposed between all portions of the carbon fiber textile and the uncured concrete such that no portion of the carbon fiber textile is in contact with the uncured concrete.

As will be appreciated from the embodiments described above, the method may be performed adjacent the structural element, such that the structural composite further comprises the structural element. As such, in some such embodiments, the method further comprises disposing the first or second layer adjacent the surface of the structural element. In particular embodiments, the method further comprises disposing the first layer adjacent the surface of the structural element prior to forming the second layer adjacent the first layer. In such particular embodiments, the uncured resin of the first layer may be disposed between and in contact with each of the carbon fiber textile of the first layer and the surface of the structural element. In certain other embodiments, the method further comprises forming the second layer adjacent the surface of the structural element. In such other embodiments, forming the second layer adjacent the surface of the structural element may comprise disposing the uncured concrete onto the surface of the structural element. Likewise, forming the second layer adjacent the surface of the structural element may comprise forming the uncured concrete in situ on the surface of the structural element. It is thus to be appreciated that in some embodiments, the substrate is the structural element. In other embodiments, the substrate is different than the structural element, and the structural composite may comprise either or both of the substrate and the structural element.

The method further includes (iii) curing the first and second layers, thereby forming the structural composite.

Typically, curing the first and second layers comprises curing both the uncured resin and also the uncured concrete. Accordingly, the first layer may be cured before, during, and/or after curing the second layer. Likewise, the uncured resin may be cured before, during, and/or after curing the uncured concrete. Moreover, any suitable curing method may be used, such as setting, hardening, cross-linking, polymerizing, gelatinizing, vulcanizing, and the like, or combinations thereof. While forming the structural composite typically comprises curing both the uncured resin and also the uncured concrete, it is to be appreciated that the uncured resin and the uncured concrete may be cured by the same or different methods as one another. Thus, it is also to be appreciated that any one or more method(s) can be used to cure the uncured resin and/or uncured concrete. Curing the uncured resin and/or uncured concrete may comprise physical, chemical, or electronic curing methods, such as curing methods initiated by exposing the uncured resin and/or uncured concrete to heat, moisture, pressure, chemical additives such as catalysts and/or cross-linkers, electron beams such as infrared and/or ultraviolet (UV) radiation, and the like, or combinations thereof. Alternatively, in some embodiments no external curing conditions need be utilized to cure the first and/or second layer. Rather, in such embodiments, one or both of the first and second layers may be cured under ambient conditions. Likewise, in some embodiments, the uncured resin and/or uncured concrete may be cured under ambient conditions.

In particular embodiments, the method further comprises forming a third layer adjacent the first or second layer, and subsequently curing the third layer. The third layer may be formed by any of the methods described above. Likewise, the third layer may optionally be cured, such as by any of the curing methods described above. Curing the third layer may be performed before, during, and/or after curing the first and second layers. Typically, the third layer comprises a structural material. The structural material may be any material suitable for use in a structural composite, such as concrete, carbon fiber, fiberglass, plastic, resin, steel, wood, stone, and the like, or combinations thereof. In some embodiments, the structural material is uncured concrete, which may be the same as or different than the uncured concrete of the second layer. Accordingly, in certain embodiments, the third layer is the same as the second layer. In some other embodiments, the third layer is different than the second layer. Likewise, the third layer may be formed by the same or different method utilized to form the first or second layer.

In particular embodiments, the method comprises forming the third layer adjacent the first layer, such that the structural composite comprises the first layer disposed between the second and third layers (i.e., a “sandwich” configuration). In such embodiments, the uncured resin is typically further disposed between and in contact with the carbon fiber textile of the first layer and the structural material of the third layer. In some embodiments, however, the method comprises forming the third layer adjacent the second layer, such that the structural composite comprises the second layer disposed between the first and third layers. In such some embodiments, the uncured concrete of the second layer is typically disposed adjacent and in contact with the structural material of the third layer.

The method may further comprise forming a fourth layer adjacent the second or third layer, and subsequently curing the fourth layer. The fourth layer may be the same or different as any of the first, second, and third layers. As such, the fourth layer may be formed by any one or more of the methods described above. Likewise, the fourth layer may optionally be cured, such as by any of the curing methods described above. Curing the fourth layer may be performed before, during, and/or after curing the first and second layers. Similarly, curing the fourth layer may be performed before, during, and/or after curing the third layer. Typically, forming the fourth layer comprises combining a structural material and an uncured resin. The uncured resin may be the same as or different than the uncured resin of the first layer, and is typically selected from the resins described above. The structural material may be the same as or different than the structural material of the third layer, and is typically selected from the structural materials described above. The fourth layer is typically formed adjacent the third layer such that the uncured resin of the fourth layer is disposed at least between and in contact with the structural material of the fourth layer and the structural material of the third layer. In certain embodiments, the fourth layer is the same as the first layer. In some embodiments, the fourth layer is formed adjacent the second layer, such that the uncured resin of the fourth layer is disposed at least between and in contact with the structural material of the fourth layer and the uncured concrete of the second layer.

In some embodiments, the method comprises forming more than one of each of the first and second, and/or third and fourth layers. Accordingly, it is to be appreciated that the method may comprise repeatedly forming first, second, third, and/or fourth layers as described above, such that the structural composite may comprise any number of the first, second, third, and/or fourth layers. For example, in certain embodiments the method comprises forming 1, 2, 3, 4, 5, 6, 7, 8, 9, or 10 of the first and second layers, and 0, 1, 2, 3, 4, 5, 6, 7, 8, 9, or 10 of the third and/or fourth layers.

The invention also provides a structural composite formed in accordance with the method. In particular, the invention provides a structural composite comprising first and second layers. The first layer comprises a resin and a carbon fiber textile, each of which may be selected, respectively, from the resins and carbon fiber textiles described above. The second layer comprises concrete, such as any one or more of the concretes described above. The first and second layers of the structural composite are disposed adjacent to and in contact with one another, such that the resin of the first later is disposed at least between and in contact with each of the carbon fiber textile of the first layer and the concrete of the second layer.

The structural composite may further comprise a third layer disposed adjacent to and in contact with the first or second layer. The third layer typically comprises a structural material, such as one of those described above. The structural composite may also comprise a fourth layer disposed adjacent to and in contact with the third layer. The fourth layer typically comprises a resin and a structural material. The resin of the fourth layer may be any of the resins described above. The structural material of the fourth layer may be any of the structural materials described above, and may be the same as or different than the structural material of the third layer. Typically, the third and fourth layers of the structural composite are disposed adjacent to and in contact with one another such that the resin of the fourth layer is disposed at least between and in contact with each of the structural material of the third layer and the structural material of the second layer.

While the structural composite comprises at least 2 of the layers (e.g. one of each of the first and second layers), it is to be appreciated that the structural composite may comprise more than one of each of the first, second, third, and/or fourth layers. For example, in certain embodiments the structural composite comprises 1, 2, 3, 4, 5, 6, 7, 8, 9, or 10 of each of the first and second layers, and 0, 1, 2, 3, 4, 5, 6, 7, 8, 9, or 10 of the third and/or fourth layers. As such, the structural composite may comprise as many as 40 of the layers (e.g. ten of each of the first, second, third, and fourth layers).

The structural composite may be formed adjacent a structural element, such as any of the structural elements described above. As such, the structural composite may be integrally formed with the structural element.

Typically, the method and structural composite of the present invention are utilized to construct new structural elements and structures, reinforce and/or retrofit existing structural elements and structures, and/or to repair damaged structural elements and structures. The method may be utilized any number of times to form any number of the structural composites for use in constructing, reinforcing, retrofitting, and/or repairing a structural element or structure. Likewise, the method may be utilized to construct, reinforce, retrofit, and/or repair multiple portions of a particular structural element, or multiple structural elements of a particular structure.

With reference to the Figures, a structural composite formed in accordance with the method is shown, with the first and second layers (and thus the uncured resin and uncured concrete) in a cured state. Accordingly, the terms “resin” and “concrete” utilized in reference to the Figures indicate a cured resin and a cured concrete, respectively. However, the Figures may also be understood in view of the method described herein, such that terms such as “resin” and “concrete” may be understood to indicate uncured resin and uncured concrete. As such, it is to be understood that the Figures may illustrate the structural composite formed in accordance with the method, as described in detail below, and also the method itself in view of the description of the method herein.

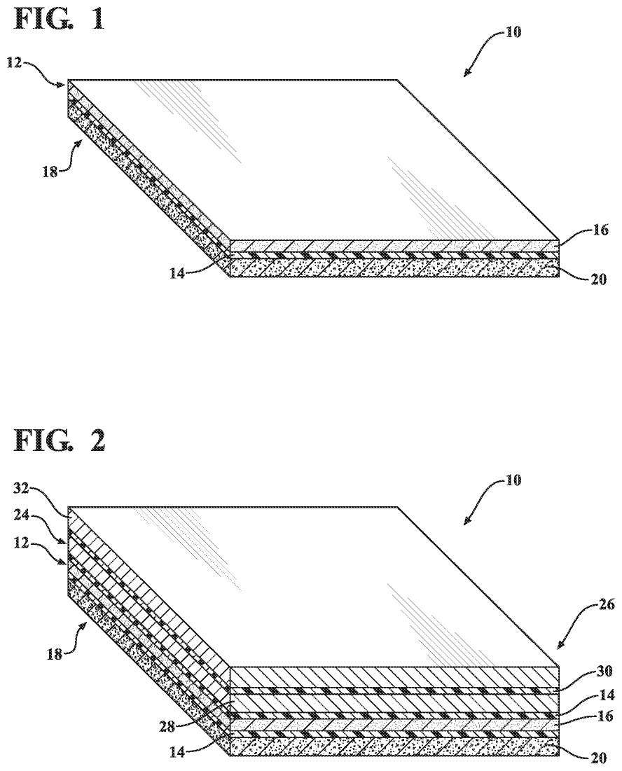

With reference to the specific embodiments of the Figures, wherein like numerals generally indicate like parts throughout the several views, a structural composite formed in accordance with the method is shown generally at 10 in FIG. 1. The structural composite 10 comprises a first layer 12, which comprises a first resin 14 and a carbon fiber textile 16. The structural composite 10 further comprises a second layer 18 comprising concrete 20 disposed adjacent the first layer 12. The structural composite 10 comprises the first resin 14 disposed between and in contact with each of the carbon fiber textile 16 and concrete 20.

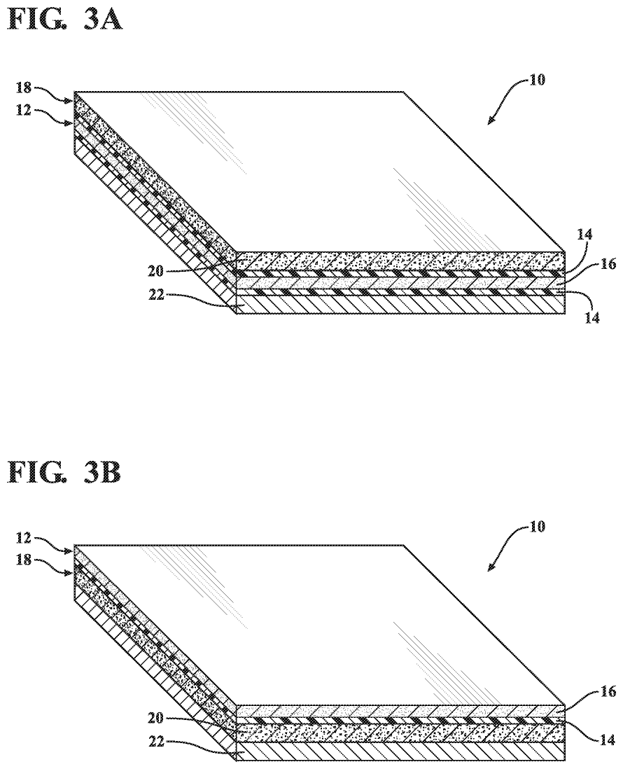

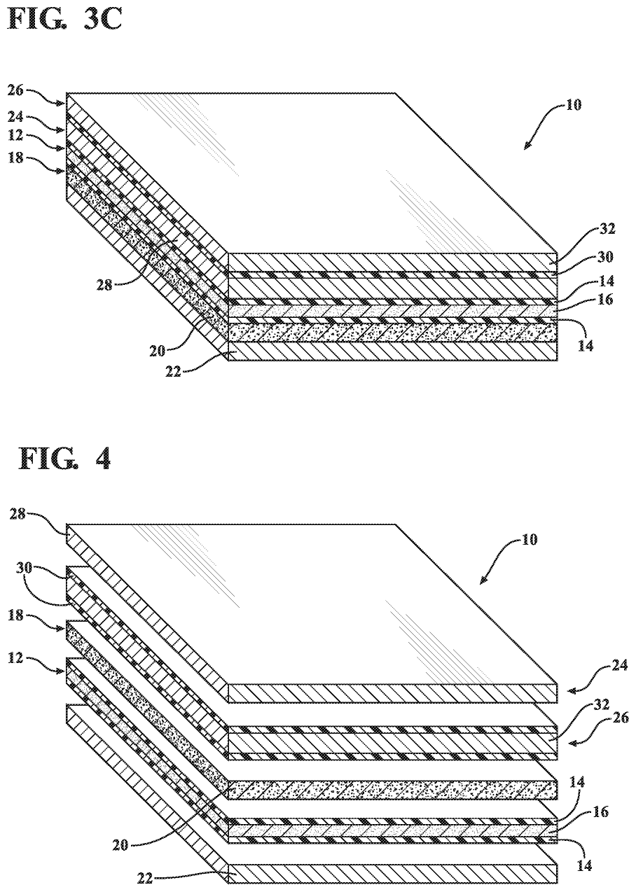

FIG. 2 shows the structural composite 10, as exemplified in FIG. 1, further comprising a third layer 24 and a fourth layer 26. More specifically, FIG. 2 shows the third layer 24 comprising a first structural material 28, disposed adjacent the first layer 12. The first resin 14 is disposed between and in contact with each of the carbon fiber textile 16 and the first structural material 28. FIG. 3 also shows the fourth layer 26 comprising a second resin 30 and a second structural material 32. The fourth layer 26 is disposed adjacent the third layer 24, such that the second resin 30 is disposed between and in contact with each of the first and second structural materials 28 and 32. As described above, the first and second resins may be the same as or different from one another. Likewise, the first and second structural materials may be the same as or different from one another.

FIGS. 3a-c show the structural composite 10 further comprising a structural element 22. In particular, FIG. 3a shows the structural composite 10, as exemplified in FIG. 1, comprising the first layer 12 disposed adjacent to and in contact with the structural element 22. FIG. 3b shows the structural composite 10 comprising the second layer 18 disposed adjacent to and in contact with the structural element 22. FIG. 3c shows the structural composite 10, as exemplified in FIG. 2, comprising the second layer 18 disposed adjacent to and in contact with the structural element 22.

FIG. 4 shows an exploded view of the structural composite 10. In particular, FIG. 4 shows the structural composite 10 comprising the first layer 12 disposed adjacent a structural element 22, and the second layer 18 comprising concrete 20 disposed adjacent the first layer 12. The structural composite 10 further comprises the fourth layer 26 disposed adjacent the second layer 18. The fourth layer 26 comprises the second resin 30 and the second structural material 32. The structural composite 10 also comprises the third layer 24 disposed adjacent to the fourth layer 26.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

Likewise, it is also to be understood that the appended claims are not limited to express and particular compounds, compositions, or methods described in the detailed description, which may vary between particular embodiments that fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A method of forming a structural composite, said method comprising:
(i) combining an uncured resin and a carbon fiber textile to form a first layer;
(ii) forming a second layer comprising uncured concrete adjacent the first layer, wherein the uncured concrete of the second layer is in contact with the uncured resin of the first layer; and
(iii) curing the first and second layers, thereby forming the structural composite.

2. The method of claim 1, wherein the uncured resin comprises an epoxy resin, a polyurethane resin, a polyester resin, a vinylester resin, a phenol resin, a polyamide resin, a polyimide resin, and/or a polyvinyl resin.

3. The method of claim 2, wherein the uncured resin comprises the epoxy resin.

4. The method of claim 1, wherein the carbon fiber textile is a carbon fiber fabric.

5. The method of claim 4, wherein the carbon fiber fabric is pre-cast prior to forming the first layer therewith, and the method further comprises pre-casting the carbon fiber fabric.

6. The method of claim 1, wherein combining the carbon fiber textile and the uncured resin comprises wetting or saturating the carbon fiber textile with the uncured resin to form the first layer.

7. The method of claim 1, wherein forming the second layer comprises disposing the uncured concrete onto the first layer.

8. The method of claim 7, wherein disposing the uncured concrete comprises pouring, spraying, rolling, dumping, and/or packing the uncured concrete onto the first layer.

9. The method of claim 1, wherein at least one of the first and second layers is adjacent a surface of a structural element.

10. The method of claim 9, wherein: (i) the structural element is a foundation, floor, wall, roof, support, column, pile, or slab; (ii) the structural element comprises concrete, carbon fiber, fiberglass, steel, wood, and/or stone; or (iii) both (i) and (ii).

11. The method of claim 1, further comprising forming a third layer comprising a structural material adjacent the first layer, wherein the structural material of the third layer is in contact with the uncured resin of the first layer.

12. The method of claim 11, wherein the structural material comprises uncured concrete, carbon fiber, fiberglass, steel, wood, and/or stone.

13. The method of claim 11, further comprising forming a fourth layer comprising a second uncured resin and a second structural material adjacent the third layer, wherein the second uncured resin of the fourth layer is in contact with the structural material of the third layer.

14. The method of claim 13, wherein: (i) forming the fourth layer comprises combining the second uncured resin and second structural material; (ii) the second uncured resin comprises an epoxy resin; (iii) the second structural material comprises a carbon fiber textile; or (iv) each of (i)-(iii).

15. A structural composite formed in accordance with the method of claim 1.
